(19) United States
(12) Patent Application Publication
(10) Pub. No.: US 2018/0240080 A1
(43) Pub. Date: Aug. 23, 2018

(54) EQUIPMENT MAINTENANCE SYSTEM

(71) Applicant: General Electric Company, Schenectady, NY (US)

(72) Inventors: Shakti Prasad Misra, Banglaore (IN); Ganesh Gupta, Bangalore (IN); Harsha Narayana, Bangalore (IN)

(21) Appl. No.: 15/435,812

(22) Filed: Feb. 17, 2017

(51) Int. Cl. G06Q 10/00; G06Q 10/10; G07C 5/00

(52) U.S. Cl. CPC G06Q 10/20; G07C 5/006; G06Q 10/1097

(57) ABSTRACT

An equipment maintenance system includes a communication unit configured to obtain usage data indicative of usage of equipment and a maintenance frequency requirement for the equipment. The maintenance frequency requirement for the equipment dictates a lower limit on a frequency at which the equipment is to be one or more of repaired or inspected. The system also includes one or more processors configured to determine a maintenance schedule for one or more of repairing or inspecting the equipment based on the usage data and the maintenance frequency requirement. The one or more processors are configured to determine the maintenance schedule such that the maintenance schedule dictates the one or more of repairing or inspecting the equipment at least as often as the maintenance frequency requirement.

### FIELD

Embodiments of the subject matter disclosed herein relate to systems that determine when to perform maintenance on equipment (e.g., inspection, repair, and/or replacement of the equipment).

### BACKGROUND

Equipment such as vehicles, components of vehicles (e.g., engines, motors, cooling systems, etc.), routes on which the vehicles travel, stationary power generating systems, etc., need to be maintained to ensure continued safe operation of the equipment, as well as to prolong the useful life of the equipment. This maintenance can involve inspecting the equipment for damage or faults, repairing the equipment to fix damage or faults, or replacing the equipment (or part of the equipment) to fix damage or faults.

Operation of some equipment is subject to requirements for maintaining the equipment at designated times or at a designated frequency. For example, some railway safety regulations may require inspection of different railway equipment at regular, periodic time intervals. These regulations specify fixed and predetermined inspection frequencies that are determined by governmental or regulatory bodies. But, these requirements are not tied to or based on, and do not account for, conditions in which the equipment has operated or other physical aspects of the equipment. The requirements may be established to apply to equipment operating in a wide range of conditions, states, etc.

As a result, the required maintenance frequency for equipment may not require inspection, repair, etc., frequently enough to prevent premature failure of the equipment. The equipment operating under or in more harsh environments, the equipment in a more deteriorated state, or the equipment operating at longer time periods than other equipment may not be inspected frequently enough under the required maintenance frequency. This equipment may be inspected and/or repaired at the frequency required by the regulation, yet still prematurely fail.

### BRIEF DESCRIPTION

In one embodiment, a system (e.g., an equipment maintenance system) includes a communication unit configured to obtain usage data indicative of usage of equipment and a maintenance frequency requirement for the equipment. The maintenance frequency requirement for the equipment dictates a lower limit on a frequency at which the equipment is to be one or more of repaired or inspected. The system also includes one or more processors configured to determine a maintenance schedule for one or more of repairing or inspecting the equipment based on the usage data and the maintenance frequency requirement. The one or more processors are configured to determine the maintenance schedule such that the maintenance schedule dictates the one or more of repairing or inspecting the equipment at least as often as the maintenance frequency requirement.

In one embodiment, a method includes determining usage data indicative of usage of equipment and determining a maintenance frequency requirement for the equipment. The maintenance frequency requirement dictates a lower limit on a frequency at which the equipment is to be one or more of repaired or inspected. The method also includes determining a maintenance schedule for one or more of repairing or inspecting the equipment based on the usage data and the maintenance frequency requirement. The maintenance schedule dictates the one or more of repairing or inspecting the equipment at least as often as the maintenance frequency requirement.

In one embodiment, a system (e.g., a maintenance system) includes a communication unit configured to obtain usage data indicative of usage of equipment and a maintenance frequency requirement for the equipment. The maintenance frequency requirement for the equipment dictates a lower limit on a frequency at which the equipment is to be one or more of repaired or inspected. The system also includes one or more processors configured to determine a maintenance schedule for one or more of repairing or inspecting the equipment based on the usage data and the maintenance frequency requirement. The one or more processors are configured to determine the maintenance schedule such that the maintenance schedule dictates the one or more of repairing or inspecting the equipment at least as often as the maintenance frequency requirement. The one or more processors are configured to revise the maintenance schedule based on one or more of a change in the maintenance frequency requirement, historical accidents of other equipment of a common type of equipment, or historical defects in other equipment of a common type of equipment.

### BRIEF DESCRIPTION OF THE DRAWINGS

The subject matter described herein will be better understood from reading the following description of non-limiting embodiments, with reference to the attached drawings, wherein below:

FIG. 1 illustrates one embodiment of an equipment maintenance system;

FIG. 2 is another illustration of the maintenance system shown in FIG. 1 and sensing devices also shown in FIG. 1 according to one embodiment; and

FIG. 3 illustrates a flowchart of one embodiment of a method for maintaining equipment.

### DETAILED DESCRIPTION

One or more embodiments of the inventive subject matter described herein provide equipment maintenance systems and methods that predict when inspection of equipment is to occur for each piece of equipment. Optionally, the systems and methods can automatically communicate a signal to a repair system (e.g., a robotic system) that automatically inspects, repairs, or otherwise maintains the equipment based on the prediction determined by the systems and methods.

To generate the inspection prediction, the systems and methods digitally simulate certain aspects of the equipment that influence the frequency at which maintenance is to occur. The maintenance can include inspection of the equipment, but optionally can include repair or replacement of the equipment or one or more components of the equipment. The simulation can be based on a variety of factors representative of usage of the equipment. For example, for a crossing between a rail route and another route, the usage of the crossing can be represented by axle loads (e.g., the weight borne by axles of vehicles traveling over or through the crossing), traffic (e.g., the number of vehicles traveling over or through the crossing), manufacturing condition (e.g., whether components of the crossing are original parts, replaced parts, refurbished parts, etc.), weather conditions, and the like. This usage information can be used to create a digital shadow or twin of the equipment, which represents a digital simulation of the equipment in the current state of the equipment.

The usage information is used with a frequency mandate to determine when or how frequently maintenance is to be performed on the equipment. The frequency mandate dictates when or how frequently inspection or other maintenance of the equipment is to occur, and may be obtained from a regulatory or other legal requirement, a contractual agreement, or the like. Using the usage information, the frequency mandate, and/or information on previous inspections or other maintenance, a schedule for inspecting or performing other maintenance is determined. The schedule can ensure that the equipment is inspected at least as often as the frequency mandate, while ensuring that some equipment is inspected more often due to increased usage of the equipment (e.g., relative to other equipment). The schedule can be output to an operator (e.g., by color coding or otherwise indicating the urgency of the scheduled maintenance), and/or may be used to direct a repair system to automatically perform inspection or other maintenance on the equipment.

In one embodiment, the systems and methods can receive user input that provides different potential or hypothetical conditions in which the equipment may operate in the future. The systems and methods can apply these conditions to the digital twin of the equipment to simulate usage of the equipment under the potential or hypothetical conditions. The systems and methods can determine, using this simulated usage, if more frequent inspections or other maintenance are needed.

At least one technical effect of the subject matter described herein is the maintenance (e.g., inspection, repair, and/or replacement) of equipment in a timely manner to ensure that the required maintenance frequency is satisfied while also ensuring that equipment experiencing more extreme conditions is maintained more often. This can result in reduced downtime of the equipment (e.g., relative to only maintaining the equipment at the required frequency).

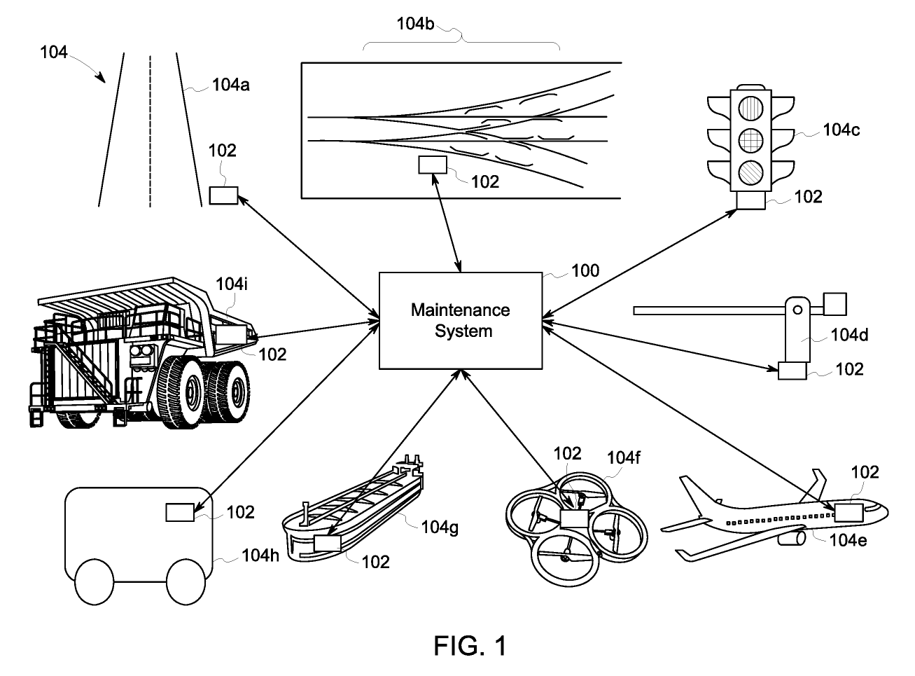

FIG. 1 illustrates one embodiment of an equipment maintenance system 100. The maintenance system is communicatively coupled (e.g., via one or more wired and/or wireless connections) with various types of equipment 104 (e.g., equipment 104A-I). In the illustrated embodiment, the maintenance system is communicatively coupled with sensing devices 102 that sense operation of the equipment. The equipment shown in FIG. 1 is provided merely as a few examples of the equipment for which the maintenance equipment can determine digital twins, which are used to determine when inspection or other maintenance is to be performed, as described herein. The equipment 104A represents a route (e.g., a road, track, waterway, aerial path, off-highway route, etc.) and/or a segment of a route (e.g., a bridge, tunnel, etc.). The sensing device that monitors operation of the route can include one or more of a scale that measures how much weight travels over the route, an optical sensor (camera, infrared sensor, photodetector, etc.) that monitors how many vehicles travel over the route, a thermometer that measures temperatures of or near the route, a precipitation sensor, a humidity sensor, or the like. The equipment 104B represents a switch, crossing, or intersection between two or more routes. The sensing device that monitors operation of the switch, crossing, or intersection can include one or more of a scale that measures how much weight travels over the switch, crossing, or intersection, an optical sensor (camera, infrared sensor, photodetector, etc.) that monitors how many vehicles travel over the switch, crossing, or intersection, a thermometer that measures temperatures of or near the switch, crossing, or intersection, a precipitation sensor, a humidity sensor, or the like.

The equipment 104C represents a signal that changes color, information that is visually presented, or the like, to warn vehicles or pedestrians of when it is safe to proceed or cross a route. The sensing device that monitors operation of the signal can be one or more of an optical sensor (camera, infrared sensor, photodetector, etc.) that monitors operation of the signal, a resistive sensor that measures the flow of electric current to and/or from the signal, or the like. The equipment 104D represents a gate that changes position to block or allow passage of vehicular traffic. The sensing device monitoring operation of the gate can include one or more of an optical sensor (camera, infrared sensor, photodetector, etc.) that monitors operation of the gate, a resistive sensor that measures the flow of electric current to and/or from the gate, or the like.

The equipment 104E represents a manned aerial vehicle. The sensing device monitoring operation of the vehicle can include a variety of sensors, such as an airspeed detector, an altitude sensor, a fuel gauge, a tachometer, a scale measuring cargo load, an engine hour meter, a thermometer, a pressure gauge, a humidity sensor, or the like. The equipment 104F represents an unmanned aerial vehicle. The sensing device monitoring operation of the vehicle can include a variety of sensors, such as an airspeed detector, an altitude sensor, a fuel gauge, a tachometer, an engine hour meter, a thermometer, a pressure gauge, a humidity sensor, a camera, or the like.

The equipment 104G represents a marine vessel or vehicle. The sensing device monitoring operation of the vessel can include a variety of sensors, such as a speed sensor, a global positioning system (GPS) receiver, a fuel gauge, a tachometer, an engine hour meter, a thermometer, a pressure gauge, a humidity sensor, or the like. The equipment 104H and 104I represent ground-based vehicles, such as an automobile, a truck, a bus, a rail vehicle, a mining vehicle, or another type of off-highway vehicle (e.g., a vehicle that is not designed or that is not legally permitted for travel on public roadways). The sensing device monitoring operation of the vehicles can include a variety of sensors, such as a fuel gauge, a tachometer, an engine hour meter, a thermometer, a pressure gauge, a humidity sensor, a camera, or the like.

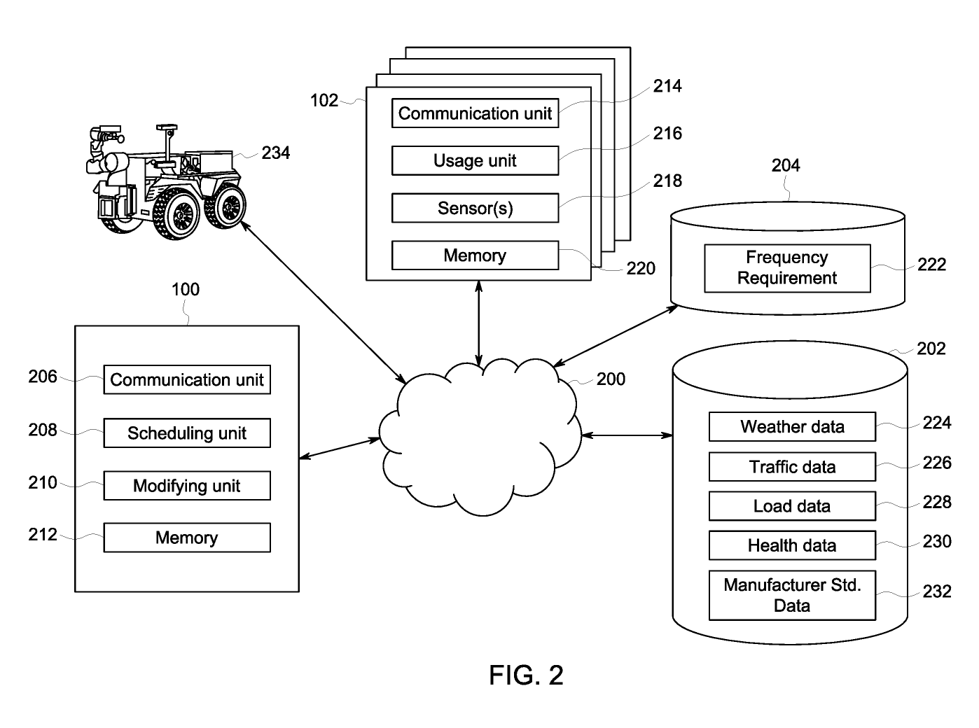

FIG. 2 is another illustration of the maintenance system 100 and sensing devices 102 shown in FIG. 1 according to one embodiment. The sensing devices include sensors 218 that measure or sense characteristics of the equipment. Examples of the sensors that may be included in the sensing devices are provided above. The sensing devices also can include memories 220, such as computer readable memory devices (e.g., computer hard drives, flash drives, optical drives, removable drives, etc.) that store data indicative of the characteristics of the equipment that are sensed by the sensors. The sensing device can include usage units 216 that represent hardware circuitry including and/or connected with one or more processors (e.g., one or more microprocessors, field programmable gate arrays, and/or integrated circuits) that translate or form usage data based on the characteristics of the equipment that are sensed by the sensors. The usage units can create usage data representative of these characteristics, which is stored in the memories and/or communicated to the maintenance system via a communication unit 214.

The communication unit of the sensing device represents transceiving circuitry and associated hardware that communicates (e.g., wirelessly and/or via wired connections) the usage data to the maintenance system. The communication unit of the sensing device can communicate the usage data via one or more computer networks 200, which may represent or include at least a portion of the Internet, an intranet, or the like. The communication unit can communicate usage data from the usage unit, the sensor, and/or the memory to the maintenance system. The communication unit can communicate identification data of the equipment (described below) to the maintenance system.

The maintenance system may include a communication unit 206 that receives the usage data and/or identification data from the sensing devices. The communication unit of the maintenance system represents transceiving circuitry and associated hardware that communicates (e.g., wirelessly and/or via wired connections) with the sensing devices, one or more remotely located memories 202, 204, and/or a repair system 234 that automatically maintains equipment based on signals received from the maintenance system.

In operation, the maintenance system determines identification information of the equipment. The maintenance system includes a scheduling unit 208 and a modifying unit 210, which represent or include hardware circuitry that include and/or are connected with one or more processors (e.g., one or more microprocessors, integrated circuits, and/or field programmable gate arrays) that perform operations described herein. The scheduling unit can receive the identification equipment of one or more pieces of equipment via the communication unit of the maintenance system. The sensor that is operably coupled with the equipment can provide the identification information to the maintenance system via the communication units 206, 214 communicating via the network(s) 200, such as by the sensor sending identification data that identifies the equipment to the maintenance system via wired and/or wireless connections.

The identification data can include or represent a location of the equipment. This location may be a geographic location of the equipment or a relative location of the equipment (e.g., the vehicle is between two other identified vehicles). The identification data can include or represent a unique identifier of the equipment, such as a serial number or other numeric, alphanumeric, etc., sequence that identifies and distinguishes the equipment from other similar or dissimilar equipment.

The identification data can include or represent a configuration of the equipment. The configuration can be a state or arrangement of the equipment. In one example, the configuration can represent whether the equipment is in a functional state or a non-functional state. As another example, the configuration can represent the type of equipment (e.g., vehicular, signaling, propulsion-generating, electronic, etc.) or a type of usage of the equipment (e.g., an engine operating to propel a vehicle versus generate electric current for uses other than propelling a vehicle). The identification data can be sensed by the sensor or can be programmed into the equipment or sensor. For example, the identification data can be added to or otherwise stored in the memory of the sensor by an operator or user of the sensing unit.

The scheduling unit of the maintenance system also determines usage data of the equipment. The sensor can provide sensed data to the usage unit, which determines or creates the usage data. The usage data can then be communicated to the scheduling unit via the communication units 206, 214 and the network(s). The usage data can represent the extent to which the equipment is or has been used. For example, the usage data can indicate how many vehicles have traveled over the route, through the intersection, past the signal, and/or through the raised gate. As another example, the usage data can indicate how often or frequently the switch has changed states or positions, how often or frequently the signal has changed, how often or frequently the gate has changed positions, how long the vehicle has traveled, how many operational cycles have been performed by the equipment (where an operational cycle is activation of equipment, performance of some work by the equipment, and deactivation of the equipment), how much cargo has been moved by the equipment, how heavy of cargo was carried by the equipment, how far the equipment has traveled, how long the equipment has been used, a weight of the equipment, etc. In one embodiment, the usage data can include or represent external conditions to which the equipment is or has been exposed. For example, the usage data can indicate weather conditions under which the equipment has operated. The weather conditions can include ambient temperatures, types and/or amounts of precipitations, humidity, pressures, etc.

Optionally, the scheduling unit of the maintenance system can receive various types of usage data from other sources. A memory 202 can represent one or more servers, computer hard drives, databases, etc., that store one or more types of usage data. The memory may represent several separate memories that separately store different types of usage data. The usage data stored in the memory or memories 202 can include weather data 224, which indicates the weather conditions in which one or more of the pieces of equipment operate. The usage data can include traffic data 226, which indicates the amount and/or weight of traffic passing over or through the equipment. The usage data can include load data 228, which indicates the weight and/or amount of cargo carried by the equipment, moving through or over the equipment, the demand placed on the equipment, etc. The usage data can include health data 230, which indicates the configuration and/or condition of the equipment. The usage data can include manufacturer standard data 232 (“Manufacturer Std. Data”), which indicates the configuration of the equipment, recommended maintenance dates or frequencies, or the like.

The scheduling unit of the maintenance system can receive the identification data and/or the usage data from the sensors operably connected with the equipment and/or may obtain the usage data from the memory or memories at regular or irregular intervals. For example, the sensors can communicate the identification data and/or the usage data at regular, periodic intervals, at irregular intervals, in response to a demand signal communicated from the maintenance system, and/or in response to operator actuation of a button, switch, lever, etc., of the equipment and/or sensors. The memory or memories storing usage data may include or be connected with a communication unit (not shown) that communicates or provides the usage data to the communication unit of the maintenance system via the network(s).

The scheduling unit of the maintenance system can determine a maintenance schedule for repairing, inspecting, and/or otherwise maintaining one or more of the equipment based on the identification data and/or usage data. The maintenance schedule can determine when the maintenance (e.g., inspection, repair, or other maintenance) is to occur for equipment, and/or what actions are to be performed during the maintenance. In one embodiment, the maintenance schedule dictates a date and/or time at which the maintenance is to occur. Optionally, the maintenance schedule can dictate a trigger point at which the maintenance is to occur. A trigger point can be an event, such as an operational cycle, a number of operational cycles, a measured temperature, a measured output, etc., of the equipment.

The maintenance schedule can be determined by the scheduling unit based on simulation of the state (e.g., condition) of the equipment based on the usage data of the equipment and optionally may be based on upcoming or expected future usage data of the equipment. For example, different usage data for different types of equipment may be associated with different amounts of deterioration (e.g., wear and tear) of the equipment. These associations may be stored in a memory 212 of the scheduling system, which can represent one or more servers, computer hard drives, flash drives, optical drives, etc.

With respect to a route as the equipment, heavier amounts of weight that have traveled over the route, larger numbers of vehicles that travel over the route, warmer temperature of or near the route, greater amounts of precipitation on the route, greater humidity at or near the route, etc., may be associated with larger designated amounts of deterioration or wear and tear of the route (e.g., designated, quantifiable values) relative to lighter amounts of weight that have traveled over the route, smaller numbers of vehicles that travel over the route, cooler temperatures of or near the route, lesser amounts of precipitation on the route, lesser humidity at or near the route, etc. With respect to a switch, crossing, or intersection as the equipment, heavier amounts of weights traveling over the switch, crossing, or intersection, more vehicles traveling over the switch, crossing, or intersection, warmer temperatures, etc., may be associated with greater deterioration or wear and tear relative to lesser values for the same usage data. Other equipment may have different amounts of deterioration or wear and tear associated with different usage data.

Discrete or quantifiable values of the usage data can be associated with designated values representative of deterioration or wear and tear. These values may be set or established by an operator of the maintenance system (e.g., in the memory of the maintenance system). Different types of equipment may be associated with different values of deterioration or wear and tear for different values of the usage data. A digital twin of equipment can be created by the scheduling unit, which represents the type of equipment (based on the identification data) and the deterioration of the equipment (based on the usage data). The digital twin may be stored in the memory of the maintenance system as a data representation of the equipment.

The scheduling unit of the maintenance system simulates deterioration of the equipment that influences the frequency at which maintenance is to occur. For example, based on usage data indicative of previous exposure and/or usage of the equipment, the scheduling unit can determine (e.g., assume) that upcoming or future usage data of the equipment will be the same or similar to the usage data indicative of previous exposure or usage of the equipment. Optionally, the scheduling unit can examine upcoming scheduled movements of vehicles, upcoming weather predictions, etc., to modify the usage data of upcoming or future usage of the equipment.

As the usage of the equipment (both past and predicted future usage) increases, the deterioration (and values of the deterioration) of the equipment increases. As the deterioration increases, the need for maintenance of the equipment also increases. The scheduling unit may associate (e.g., or determine an association from data stored in the memory of the scheduling system) different dates, times, trigger points, or maintenance frequencies with different deterioration values. For example, a first aircraft having a digital twin with a first deterioration value may have a need for maintenance at a sooner date, sooner time, sooner trigger point, and/or at a greater frequency than a second aircraft having a digital twin with a smaller, second deterioration value. The scheduling unit can store or determine the maintenance schedule for equipment based on the usage data such that the equipment having a greater deterioration value has a maintenance schedule with maintenance to be performed sooner than equipment having a smaller deterioration value.

But, the maintenance schedule that is determined by the scheduling unit may contradict or conflict with a maintenance frequency requirement 222 of the equipment. This frequency requirement optionally can be referred to as a frequency mandate. The frequency requirement dictates a lower limit on a period of time, frequency, or the like, at which maintenance is to be performed for equipment. For example, a frequency requirement for a bridge may require that the bridge be inspected at least once every five years. As another example, a frequency requirement for aircraft may require that the aircraft be inspected before each operational cycle of the aircraft. Other equipment may be associated with other frequency requirements.

The frequency requirements may be obtained by the modifying unit of the maintenance system from a memory 204. The memory 204 can represent one or more servers, computer hard drives, optical drives, etc. The memory 204 can be remotely located from the maintenance system. For example, the memory 204 can be a central storage point or repository for frequency requirements so that various maintenance systems or other systems can determine the recommended or required maintenance frequencies for equipment. In one embodiment, a frequency requirement for equipment may be a legislative or regulatory frequency requirement that is delegated or dictated by a governmental or administrative body, such as a legislative body or regulatory body. Another example is a contractual requirement which is a frequency requirement agreed to by two or more parties (e.g., an owner of the equipment and a service provider of maintenance services to the owner). Another frequency requirement is a designated frequency requirement dictated by an owner, lessor (entity that owns but leases the equipment), lessee (entity that leases the equipment from the owner), or operator of the equipment. The frequency requirements may be communicated to the modifying unit of the scheduling system via the network(s) and the communication unit of the scheduling system. The frequency requirements may be obtained from the memory 204 via the communication unit of the maintenance system and the network(s), and/or may be locally stored in the memory of the maintenance system.

The modifying unit of the maintenance system may compare the maintenance schedule determined for equipment based on the usage data with the frequency requirement for the equipment to determine if the frequencies contradict each other. The maintenance schedule and the frequency requirement may contradict each other if the maintenance schedule that is based on the usage data requires maintenance at a time that is later than the frequency requirement or at a frequency that is smaller (e.g., less often) than the frequency requirement. For example, if the maintenance system determines that the maintenance schedule for a bridge in a rural area that is rarely used dictates inspection of the bridge once every one hundred years, but a legislated frequency requirement dictates that the bridge be inspected once every ten years, then the maintenance schedule that is determined for the bridge contradicts the frequency requirement for the bridge.

In response to determining that the maintenance schedule contradicts the frequency requirement, the modifying unit of the maintenance system may modify the maintenance schedule. The maintenance schedule for equipment may be modified by the modifying unit to require maintaining the equipment at least as often as the frequency requirement. For example, if the maintenance schedule for the bridge in the rural area dictates inspection of the bridge once every one hundred years, but the frequency requirement dictates that the bridge be inspected once every ten years, then the modifying unit can change the maintenance schedule to require inspection of the bridge at least once every ten years instead of once every one hundred years. The modified schedule may be referred to as a revised schedule or revised timetable for performing maintenance on the equipment.

The frequency requirement may change over time. For example, as regulatory or other governmental bodies change, as public policies change, as accidents occur, as changes in technology occur, etc., more frequent or less frequent inspections or other maintenance on equipment may be needed. The modifying unit may check on the frequency requirement stored in the memory 204 on a regular, irregular, or on-demand basis to determine when the frequency requirement for equipment changes. Responsive to determining that a frequency requirement for equipment has changed, the modifying unit can compare the revised schedule or the maintenance schedule (that is not revised) currently being used to maintain equipment with the modified frequency requirement. Based on this comparison, the modifying unit can determine whether the revised schedule or the maintenance schedule needs to be revised and, if so, revise the revised schedule or the maintenance schedule. This can ensure that the maintenance schedule used to maintain equipment keeps up with changing frequency requirements so that equipment is always inspected at least as often as the current frequency requirement.

As another example, the maintenance schedule may be revised by the modifying unit based on a history of accidents, damage, or defects of other equipment. Several of the same type of equipment may be monitored by the scheduling unit and/or modifying unit of the maintenance system. Responsive to at least a designated threshold number or percentage (e.g., 10%) of the same type of equipment experiencing the same damage, accident, or defect, the modifying unit can revise the maintenance schedule or revised schedule. For example, the usage data of several different automobiles may be concurrently monitored by the scheduling unit and/or modifying unit. If at least the designated amount of vehicles experience the same damage, accident, or defect (e.g., the airbags in automobiles failing, flat tires in the automobiles, etc.), the modifying unit can change the maintenance schedule or revised schedule to schedule more frequent inspections or inspections to occur sooner than otherwise scheduled.

In one embodiment, the modifying unit communicates a control signal to one or more robotic systems 234 responsive to determining that equipment needs to be maintained (e.g., inspected, repaired, or replaced) based on the revised schedule or maintenance schedule (that is not revised due to a lack of conflict with the frequency requirement). The robotic system can represent robotic machinery that automatically inspects, repairs, or replaces equipment responsive to receiving the control signal. The control signal may be communicated by the communication unit 206 via the network(s) 200. The robotic system can automatically inspect the equipment by obtaining images and/or video of the equipment and communicating the images and/or video to an operator of the equipment or maintenance system. The robotic system can automatically repair the equipment by removing a damaged component of the equipment, replacing a damaged component of the equipment, applying a coating to the equipment, etc. In doing so, the robotic system may change the state of the equipment from a faulty or inoperative state to a repaired or operative state.

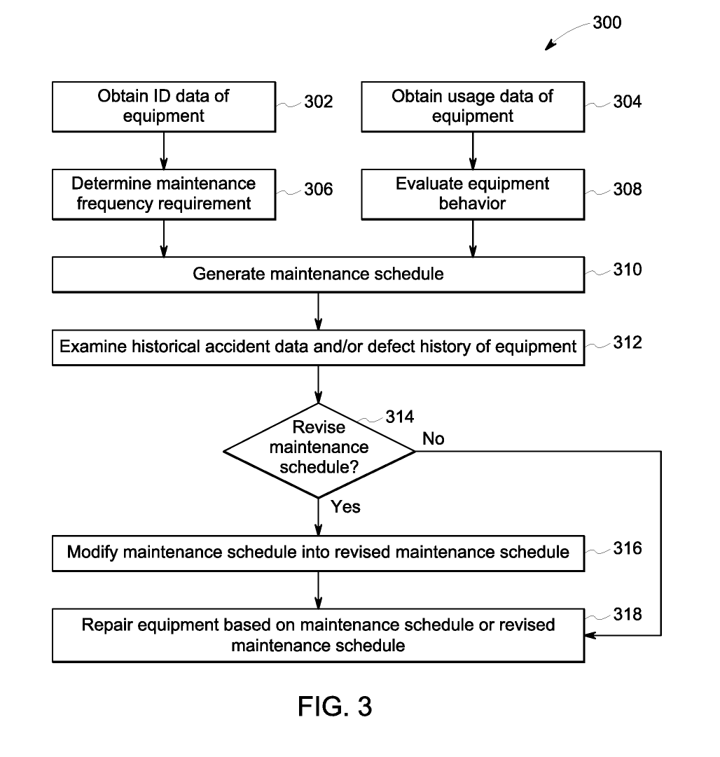

FIG. 3 illustrates a flowchart of one embodiment of a method 300 for maintaining equipment. The method 300 may represent operations performed by the scheduling unit and/or modifying unit of the maintenance system shown in FIG. 2, and optionally may represent operations performed by the robotic system shown in FIG. 2. The method 300 can represent operations performed by the scheduling unit and/or modifying unit under the instructions of software operating on processors of the scheduling unit and/or modifying unit, or may represent an algorithm that can be used to create such a software application.

At 302, identification (ID) data of equipment is obtained. The scheduling unit of the maintenance system can obtain the identification data from the sensing units of equipment via communication between the communication units over or through the network(s). At 304, usage data of the equipment is obtained. The usage data may be obtained by the scheduling unit from the sensing units and/or the memories 202, as described above. At 306, a maintenance frequency requirement is determined. This frequency requirement may be obtained by the modifying unit of the maintenance system from the memory 204 or from another source. At 308, behavior of the equipment is evaluated. For example, the usage data of the equipment is examined by the scheduling unit to determine the amount of wear and tear, or deterioration, potentially experienced by the equipment based on the usage data. The operations described in connection with 302, 304, 306, and/or 308 may be performed concurrently or simultaneously.

At 310, a maintenance schedule for the equipment is generated. As described above, this maintenance schedule can be based on the usage data and the identification of the equipment. Because different types of equipment experiencing different amounts of wear and tear may require maintenance at different times, the maintenance schedules for different pieces of equipment (but the same type of equipment) may be different. The maintenance schedules can be created by the scheduling unit so that the equipment having the greatest amount of usage and/or used in harsher conditions is scheduled for maintenance more often or sooner than other equipment.

At 312, historical accident data and/or defect history of the equipment is examined. The historical accident data can indicate previous accidents of the same equipment or different equipment (but the same type of equipment). The defect history can indicate previously detected defects or faults of the same equipment or different equipment (but the same type of equipment). The accident data and/or defect history can be obtained by the scheduling unit and/or modifying unit from the sensing units or from the memory 202.

At 314, a determination is made as to whether the maintenance schedule is to be revised. The maintenance schedule may be revised responsive to determining that the next time maintenance is scheduled is longer than the time at which maintenance is to occur according to the frequency requirement (determined at 306). Optionally, the maintenance schedule may be revised responsive to determining that the frequency at which maintenance is scheduled is less frequent than the frequency at which maintenance is required to occur according to the frequency requirement. As another example, the maintenance schedule may be revised responsive to determining that the accident data and/or history of defects associated with the equipment or same type of equipment indicates that maintenance should occur sooner or more often than is provided for in the maintenance schedule generated at 310. If the maintenance schedule is to be revised, then flow of the method 300 can proceed toward 316. Otherwise, if the maintenance schedule does not need to be revised, then flow of the method 300 can proceed toward 318.

At 316, the maintenance schedule is revised into a revised schedule. The schedule may be revised by the modifying unit when maintenance is scheduled for equipment to ensure that the maintenance occurs at least as soon as (or at least as frequent as) the maintenance required by the frequency requirement. As another example, the schedule may be revised when equipment of the same type is experiencing the same or similar accidents or defects, and maintenance of the equipment may be needed sooner than provided for in the maintenance schedule to avoid an accident or repair the defect in the equipment.

Optionally, the method 300 may not both create a maintenance schedule and revise the maintenance schedule. Instead, the method 300 may create the schedule based on the usage data of the equipment, the frequency requirement, the accident data, and/or the defect data so that the schedule, when first created, satisfies or does not conflict with the frequency requirement.

At 318, the equipment is maintained based on the maintenance schedule or the revised schedule. For example, the modifying unit may direct the communication unit of the maintenance system to send a control signal to the robotic system to direct the robotic system to automatically perform the inspection, repair, or other maintenance of the equipment according to the maintenance schedule or the revised schedule, as appropriate.

In one embodiment, a system (e.g., an equipment maintenance system) includes a communication unit configured to obtain usage data indicative of usage of equipment and a maintenance frequency requirement for the equipment. The maintenance frequency requirement for the equipment dictates a lower limit on a frequency at which the equipment is to be one or more of repaired or inspected. The system also includes one or more processors configured to determine a maintenance schedule for one or more of repairing or inspecting the equipment based on the usage data and the maintenance frequency requirement. The one or more processors are configured to determine the maintenance schedule such that the maintenance schedule dictates the one or more of repairing or inspecting the equipment at least as often as the maintenance frequency requirement.

Optionally, the system also includes a robotic repair system that automatically repairs the equipment responsive to receiving a signal from the one or more processors based on the maintenance schedule.

Optionally, the equipment is one or more of an automobile, a rail vehicle, a truck, a marine vessel, a mining vehicle, an aerial drone, or another aerial vehicle.

Optionally, the equipment is one or more of a switch at an intersection between two or more routes, a light signal, or a gate that operates to block passage of traffic over a segment of a route.

Optionally, the usage data includes one or more of a weather condition, an amount of traffic passing over or through the equipment, a distance that the equipment has moved, an amount of time that the equipment has been actively used, or a total weight or a total mass on the equipment.

Optionally, the maintenance frequency requirement for the equipment comprises a legislative requirement.

Optionally, the one or more processors are configured to one or more of create or modify a digital twin of the equipment based on the identification data, the digital twin including a data representation of the equipment and simulated usage of the equipment based on the usage data.

Optionally, the one or more processors are configured to modify the maintenance schedule into a revised schedule responsive to a change in the maintenance frequency requirement.

Optionally, the one or more processors are configured to modify the maintenance schedule into a revised schedule also based on historical accidents of other equipment of a common type of equipment.

Optionally, the one or more processors are configured to modify the maintenance schedule into a revised schedule also based on historical defects in other equipment of a common type of equipment.

In one embodiment, a method includes determining usage data indicative of usage of equipment and determining a maintenance frequency requirement for the equipment. The maintenance frequency requirement dictates a lower limit on a frequency at which the equipment is to be one or more of repaired or inspected. The method also includes determining a maintenance schedule for one or more of repairing or inspecting the equipment based on the usage data and the maintenance frequency requirement. The maintenance schedule dictates the one or more of repairing or inspecting the equipment at least as often as the maintenance frequency requirement.

Optionally, the method also includes automatically repairing the equipment using a robotic repair system based on the maintenance schedule.

Optionally, the equipment is one or more of a vehicle, a switch at an intersection between two or more routes, a light signal, or a gate that operates to block passage of traffic over a segment of a route.

Optionally, the usage data includes one or more of a weather condition, an amount of traffic passing over or through the equipment, a distance that the equipment has moved, an amount of time that the equipment has been actively used, or a total weight or a total mass on the equipment.

Optionally, the method also includes modifying the maintenance schedule into a revised schedule based on one or more of a change in the maintenance frequency requirement, historical accidents of other equipment of a common type of equipment, or historical defects in other equipment of a common type of equipment.

In one embodiment, a system (e.g., a maintenance system) includes a communication unit configured to obtain usage data indicative of usage of equipment and a maintenance frequency requirement for the equipment. The maintenance frequency requirement for the equipment dictates a lower limit on a frequency at which the equipment is to be one or more of repaired or inspected. The system also includes one or more processors configured to determine a maintenance schedule for one or more of repairing or inspecting the equipment based on the usage data and the maintenance frequency requirement. The one or more processors are configured to determine the maintenance schedule such that the maintenance schedule dictates the one or more of repairing or inspecting the equipment at least as often as the maintenance frequency requirement. The one or more processors are configured to revise the maintenance schedule based on one or more of a change in the maintenance frequency requirement, historical accidents of other equipment of a common type of equipment, or historical defects in other equipment of a common type of equipment.

Optionally, the system also includes a robotic repair system that automatically repairs the equipment responsive to receiving a signal from the one or more processors based on the maintenance schedule that is revised.

Optionally, the usage data includes one or more of a weather condition, an amount of traffic passing over or through the equipment, a distance that the equipment has moved, an amount of time that the equipment has been actively used, or a total weight or a total mass on the equipment.

Optionally, the maintenance frequency requirement for the equipment comprises a legislative requirement.

Optionally, the maintenance frequency requirement for the equipment comprises a contractual requirement.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

The above description is illustrative and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Other embodiments may be apparent to one of ordinary skill in the art upon reviewing the above description. The scope of the inventive subject matter should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure. And, as used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
a communication unit configured to obtain usage data indicative of usage of equipment and a maintenance frequency requirement for the equipment, the maintenance frequency requirement for the equipment dictating a lower limit on a frequency at which the equipment is to be one or more of repaired or inspected; and
one or more processors configured to determine a maintenance schedule for one or more of repairing or inspecting the equipment based on the usage data and the maintenance frequency requirement, wherein the one or more processors are configured to determine the maintenance
schedule such that the maintenance schedule dictates the one or more of repairing or inspecting the equipment at least as often as the maintenance frequency requirement.

2. The system of claim 1, further comprising a robotic repair system that automatically repairs the equipment responsive to receiving a signal from the one or more processors based on the maintenance schedule.

3. The system of claim 1, wherein the equipment is one or more of an automobile, a rail vehicle, a truck, a marine vessel, a mining vehicle, an aerial drone, or another aerial vehicle.

4. The system of claim 1, wherein the equipment is one or more of a switch at an intersection between two or more routes, a light signal, or a gate that operates to block passage of traffic over a segment of a route.

5. The system of claim 1, wherein the usage data includes one or more of a weather condition, an amount of traffic passing over or through the equipment, a distance that the equipment has moved, an amount of time that the equipment has been actively used, or a total weight or a total mass on the equipment.

6. The system of claim 1, wherein the maintenance frequency requirement for the equipment comprises a legislative requirement.

7. The system of claim 1, wherein the one or more processors are configured to one or more of create or modify a digital twin of the equipment based on the identification data, the digital twin including a data representation of the equipment and simulated usage of the equipment based on the usage data.

8. The system of claim 1, wherein the one or more processors are configured to modify the maintenance schedule into a revised schedule responsive to a change in the maintenance frequency requirement.

9. The system of claim 1, wherein the one or more processors are configured to modify the maintenance schedule into a revised schedule also based on historical accidents of other equipment of a common type of equipment.

10. The system of claim 1, wherein the one or more processors are configured to modify the maintenance schedule into a revised schedule also based on historical defects in other equipment of a common type of equipment.

11. A method comprising:
determining usage data indicative of usage of equipment;
determining a maintenance frequency requirement for the equipment, the maintenance frequency requirement dictating a lower limit on a frequency at which the equipment is to be one or more of repaired or inspected; and
determining a maintenance schedule for one or more of repairing or inspecting the equipment based on the usage data and the maintenance frequency requirement, wherein the maintenance schedule dictates the one or more of repairing or inspecting the equipment at least as often as the maintenance frequency requirement.

12. The method of claim 11, further comprising automatically repairing the equipment using a robotic repair system based on the maintenance schedule.

13. The method of claim 11, wherein the equipment is one or more of a vehicle, a switch at an intersection between two or more routes, a light signal, or a gate that operates to block passage of traffic over a segment of a route.

14. The method of claim 11, wherein the usage data includes one or more of a weather condition, an amount of traffic passing over or through the equipment, a distance that the equipment has moved, an amount of time that the equipment has been actively used, or a total weight or a total mass on the equipment.

15. The method of claim 11, further comprising modifying the maintenance schedule into a revised schedule based on one or more of a change in the maintenance frequency requirement, historical accidents of other equipment of a common type of equipment, or historical defects in other equipment of a common type of equipment.

16. A system comprising:
a communication unit configured to obtain identification data for equipment, usage data indicative of usage of the equipment, and a regulatory maintenance frequency requirement for the equipment;
one or more processors configured to determine a maintenance schedule for one or more of repairing or inspecting the equipment based on the identification data and the usage data,
wherein the one or more processors also are configured to modify the maintenance schedule into a revised schedule based on a comparison between the regulatory maintenance frequency requirement and the maintenance schedule that is based on the identification data and the usage data,
wherein the revised schedule dictates the one or more of repairing or inspecting the equipment at least as often as the regulatory maintenance frequency requirement.

17. The system of claim 16, wherein the identification data includes one or more of a location of the equipment, an amount of vehicular traffic passing over or through the equipment, a functional or non-functional state of the equipment, or a type of usage of the equipment.

18. The system of claim 16, wherein the usage data is one or more of a weather condition to which the equipment has been exposed, an amount of time that the equipment has been used, or a total weight or a total mass on the equipment.

19. The system of claim 16, wherein the regulatory maintenance frequency requirement for the equipment dictates a lower limit on a frequency at which the equipment is to be one or more of repaired or inspected.

20. The system of claim 16, wherein the regulatory maintenance frequency requirement for the equipment is a delegated legislative requirement.
